(19) United States
(12) Patent Application Publication
(10) Pub. No.: US 2009/0075047 A1
(43) Pub. Date: Mar. 19, 2009

(54) Textile knit fabrics with enhanced flame retardancy for mattress and household products

(76) Inventors: Osamu Masuda, New York, NY (US); Yoshio Nakahori, Nishinomiya (JP); Makoto Saijo, Kyoto (JP)

Correspondence Address: KENYON & KENYON LLP, ONE BROADWAY, NEW YORK, NY, 10004, US

(21) Appl. No.: 11/901,639

(22) Filed: Sep. 17, 2007

(51) Int. Cl. B32B 5/02; B32B 7/02

(52) U.S. Cl. 428/219; 442/136; 442/142; 442/146

(57) ABSTRACT

The invention provides flame resistant textile knit fabrics for use in mattresses and household products, particularly bed clothing products such as pillows, comforters, bed spreads, mattress covers and mattress pad ticking. More particularly, the invention provides a fabric made of yarn comprising about 50% to about 80% by weight of inherently flame retardant viscose rayon fiber, about 10% to about 25% by weight of modacrylic fiber, and about 10% to about 25% by weight of cellulosic fiber.

### FIELD OF THE INVENTION

The invention relates to a textile knit fabric blend with fire retardant properties particularly suited for use in mattresses, fiber-filled bed clothing, and upholstered furniture. More particularly, the fabric is suitable for use in pillows, comforters, bed spreads, mattress covers, mattress pads, and upholstery.

### BACKGROUND OF THE INVENTION

Flame resistant fabrics have been developed and used in the textile industry in applications such as mattresses, protective apparel, upholstery, and draperies. In some cases, the woven and/or knit fabrics, which may be synthetic or natural fibers or a blend thereof, are topically coated with a flame resistant chemical. When used in residential household products, however, these fabrics exhibit diminished flame retardant properties over time, especially when subjected to numerous washings. Moreover, most of these coated fabrics are stiff or abrasive to the human touch and may be undesirable in residential household applications, such as for use in bed clothing products.

In other cases, the fabric possesses inherent flame and heat resistant properties. For example, INDURA® developed by Westex, Inc., NOMEX® developed by Dupont, and LENZING FR® developed by Lenzing A G are well known in the protective apparel industry as fabrics with inherent flame resistant properties and high temperature applications. However, because these fabrics are generally harsh to the touch and are relatively expensive, they may be undesirable and not cost effective in residential household applications such as for use in filled bedclothing products. In addition, these fabrics are generally not available in the color white or cream, which is a further drawback in the filled bed clothing products industry. Other flame retardant fabrics, such as polyester-based flame retardant fabric, may not be suitable for bed clothing applications, as this type of fabric is prone to melting and dripping.

### SUMMARY OF THE INVENTION

In one embodiment, the invention encompasses a knit fabric blend with inherent flame resistant properties for use in household applications, particularly bed clothing.

In another embodiment, the invention encompasses a knit fabric blend comprising about 50% to about 80% by weight of flame retardant viscose rayon fiber, about 10% to about 25% by weight of modacrylic fiber, and about 10% to about 25% by weight of cellulosic fiber.

In another embodiment of the invention, the knit fabric blend comprises about 50% to about 70% by weight of flame retardant viscose rayon fiber, about 15% to about 25% by weight of modacrylic fiber, and about 15% to about 25% by weight of cellulosic fiber.

In one embodiment of the invention, the knit fabric blend has a spun yarn count of about 5/1 ecc to about 40/1 ecc. Preferably, the knit fabric blend has a spun yarn count of about 10/1 ecc to about 40/1 ecc, more preferably of about 20/1 ecc to about 40/1 ecc, and even more preferably of about 20/1 ecc to about 30/1 ecc.

### DETAILED DESCRIPTION

The invention provides a knit fabric blend with flame resistant properties suitable for use in household applications, particularly in mattress ticking applications and bed clothing. The knit fabric blend of the invention comprises a combination of a flame retardant viscose rayon fiber, a modacrylic fiber, and a cellulosic fiber.

The knit fabric blend of the invention is especially suited for use in mattresses, which are required to meet open flammability tests, such as the California Flame Resistance of Residential Mattress test TB-603, and CPSC 16 CFRPart 1633.

The terms “flame retardant” and “flame resistant” are used interchangeably herein and generally describe fabrics which, when ignited by a flame source, resist and/or prevent the spread of flames and/or heat.

Upon exposure to open flame, the knit fabric blend of the invention expands to form a layer of char, or a “char barrier”, so called because the char acts as a barrier to protect the underlying material, such as non-flame retardant foam materials making up the composite article, from direct flame and high temperatures. The char barrier and oxygen depleting gases emitted from the fibers in the fiber blend also deprive the fire of fuel, causing the flame to extinguish before igniting any encased non-flame retardant batting fabrics or fibers fills. The combination of flame retardant viscose rayon fiber, modacrylic fiber, and cellulosic fiber in the knit fabric of the invention provides a fabric exhibiting an advantageous and beneficial extinguishing power (as measured by a lower heat release and/or a faster heat release) when subjected to a flame challenge. Table 1 illustrates these properties, and also illustrates that the extinguishing power of the knit fabric of the invention is well below the criteria required by the CFR Residential Mattress Test.

The flame retardant viscose rayon in the knit fabric of the invention may be inherently flame retardant (i.e., not chemically treated, especially not treated or coated to increase flame retardancy) or may be chemically treated to be flame retardant. Preferably, the flame retardant viscose rayon is inherently flame retardant, such as viscose rayon containing silica (i.e., silicon dioxide, SiO₂).

In another embodiment of the invention, the viscose rayon fibers in the knit fabric of the invention are not inherently flame retardant, and are chemically treated, such as by topically coating the fibers with a chemical substance to produce flame retardant viscose rayon fibers. In a preferred embodiment, the viscose rayon fibers are chemically treated by treating the fibers with ammonia polyphosphate (APP). Viscose rayon fibers containing silica (i.e., silicon dioxide, SiO₂), and viscose rayon fibers that are chemically treated to be flame retardant, are known in the art and are widely available from commercial manufacturers.

The modacrylic fibers contained in the knit fabric of the invention may be any known modacrylic fibers, and may be a combination of one or more modacrylic fibers. Modacrylic fiber, as used herein, refers to any long-chain synthetic polymer composed of at least 35% but less than 85% by weight of acrylonitrile. The modacrylic fibers in the knit fabric of the invention comprise inherently flame retardant materials. Preferably, the modacrylic fibers comprise polymers with halogenated monomers which generate oxygen depleting gasses during thermal decomposition.

The cellulosic fibers used in the knit fabric of the invention may be any known cellulosic fiber, and may be a combination of one or more cellulosic fibers. The cellulosic fiber(s) need not be inherently flame retardant, and need not be treated with a topical fire resistant chemical or coating, such as, for example, boric acid or ammonia phosphate based coatings commonly used as fiber resistant coatings. In a preferred embodiment of the invention, the cellulosic fibers are not chemically treated. Preferred cellulosic fibers include untreated cotton, which is non-flame retardant. More preferably, the cellulosic fibers are a combination of non-flame retardant cotton and non-flame retardant viscose rayon. In another embodiment, the cellulosic fibers contain a blend of natural and chemically treated fibers.

The modacrylic fibers in the knit fabric of the invention generate oxygen depleting gasses when ignited by a flame source. These gases help to prevent ignition of an underlying or incased ignitable non-flame retardant fabric, while the flame retardant viscose rayon fibers, particularly inherently flame retardant viscose rayon containing silica (i.e., silicon dioxide, SiO₂), strengthen the fire barrier (the char barrier) created by the knit fabric, preventing the flames from penetrating the char barrier and igniting the underlying material.

The fabric of the invention is knitted from a yarn which comprises about 50% to about 80% by weight of inherently flame retardant viscose rayon fiber, about 10% to about 25% by weight of modacrylic fiber, and about 10% to about 25% by weight of cellulosic fiber, such as cotton.

More preferably, the yarn used to knit the fabric comprises about 50% to about 70% by weight of inherently flame retardant viscose rayon fiber, about 15% to about 25% by weight of modacrylic fiber, and about 15% to about 25% by weight of cellulosic fiber.

In a preferred embodiment of the invention, the modacrylic fiber is not chemically treated or coated. In another preferred embodiment, the viscose rayon fiber is inherently flame retardant and is not chemically treated or coated, and the modacrylic fiber is not chemically treated or coated.

The knit fabric of the invention has a spun yarn count of about 5/1 ecc to about 40/1 ecc. Preferably, the knit fabric blend has a spun yarn count of about 10/1 ecc to about 40/1 ecc, more preferably of about 20/1 ecc to about 40/1 ecc, and even more preferably of about 20/1 ecc to about 30/1 ecc.

The knit fabric of the invention preferably has a weight of about 4 oz. per sq.yd. to about 15 oz. per sq.yd. This is generally representative of the particular commodity zone in the industry for mattress barrier applications, and is expected to be cost effective.

It is believed that this range of fiber blend is optimal in that it allows the knit fabric to pass a regulatory open-flame test protocol, such as the California Flame Resistance of Residential Mattress TB-603 test, while maintaining the cost effectiveness of the fabric. Embodiments of the textile knit fabric of the intention which are used as a barrier material for mattresses are expected to pass the California TB-603 test.

The knit fabric of the invention may be manufactured using any suitable machinery used in the art for making knits, such as a circular knitting machine. Equipment which can knit 85 inch or wider width in one knitting run is preferred. This type of machinery also enables the manufacture of three layered knit fabrics, having a face layer, a filling layer, and a back surface layer.

The knit fabric of the invention is inherently flame retardant, and allows for the manufacture of products which are resistant to open flame and which may be used with conventional non-flame resistant batting and/or foams in a cost effective and a productive manner. In addition to the fire retardant properties of the knit fabric of the invention, the fabric is very supple and stretchable, especially in comparison to materials that are composed of 100% cellulosic or cellulosic/polyester blended or 100% polyester fibers. The stretchable property of the knit fabric allows the fabric to mold and conform to an underlying material, for example, filled household products such as VISCO ELASTIC foam, pillows, and mattresses.

The knit fabrics of the invention are particularly suitable for applications in the mattress industry. More specifically, the knit fabrics are well suited for use as a second layer under non-flame resistant mattress ticking to cover the inner non-flame resistant batting fabrics and/or various kinds of foams (i.e., regular urethane foams, latex foams, and visco-elastic foams) used in the mattress. In this manner, the knit fabric of the invention can be used to create a fire barrier to a non-flame resistant mattress. Moreover, the ability to mold and conform to an underlying material provides increased sleep comfort compared to conventional ticking fabrics.

In addition, the knit fabric of the invention is competitive in cost, and may be produced in white or other light colors, including cream, lemon, and beige. The knit fabric also may be manufactured readily as it does not require special spinning technology or special knitting and dyeing/finishing technology beyond those conventionally used in the industry.

It is understood that the various embodiments described herein are by way of example only, and are not intended to limit the scope of the invention. It is also understood that the various theories proposed herein as to how or why the invention works are not intended to be limiting.

### Experimental:

Specific representative embodiments of the invention will now be described. The specific embodiments disclosed herein, including the methods, materials, conditions, process parameters, and apparatus, should not be taken to limit the scope of the invention.

### EXAMPLE 1

### Knit Fabric

Knit fabric composition (weight %): 60% inherently flame retardant viscose rayon fiber, 20% Modacrylic fiber, and 20% untreated and non-flame retardant Cotton.

Ring spun yarn count: approx. 20/1 ecc.

A knit fabric having the above characteristics was used as a barrier fabric between ticking fabric and a VISCO ELASTIC foam core. The knit fabric was placed between the ticking fabric and the foam core. An open flame test protocol for residential mattresses according to California Technical Bulletin (TB)603 was conducted on the sample.

In accordance with CA Technical Bulletin 603, a mattress is placed on a support system, whereupon flames from a multi-hole propane burner impinge on the side of the mattress for a period of 50 seconds, and flames from a second multi-hole burner impinge on the top of the mattress for a period of 70 seconds. Test observations are made. When the knit fabric sample described above was subjected to CA Technical Bulletin 603, the following was observed:

TABLE 1

| | | | ACCEPTANCE |
|---|---|---|---|
| TEST CRITERIA | | RESULT | CRITERIA |
| 1. | (a) Peak Rate of Heat Release: | 51 Kw | 200 Kw maximum |
| | (b) Time at which Peak rate of | 38 seconds | None |
| | Heat release occurred: | | |
| 2. | Total Heat Release at 10 | 6.2 MJ | 25 MJ maximum |
| | Minutes | | |

Upon testing samples of the knit fabric of the invention, it was observed that the knit fabrics completely extinguished the flame shortly after removal of the dual open flame source. It was also observed that the knit fabric prevented the flame or heat source from penetrating the knit fabric and reaching the ignitable underlying combustible material (i.e., the very combustible VISCO ELASTIC foam). Finally, the knit fabric samples easily complied with CA Technical Bulletin 603.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

What is claimed is:

1. A textile fabric comprising:
flame retardant viscose rayon fiber in an amount of about 50% to about 80% by weight; modacrylic fiber in an amount of about 10% to about 30% by weight; and cellulosic fiber in an amount of about 10% to about 30% by weight;
wherein the fabric is knitted.

2. The fabric of claim 1, wherein the flame retardant viscose rayon fiber is present in an amount of about 50% to about 70% by weight; the modacrylic fiber is present in an amount of about 15% to about 25% by weight; and the cellulosic fiber is present in an amount of about 15% to about 25% by weight.

3. The fabric of claim 1, wherein the flame retardant viscose rayon fiber is present in an amount of about 60% by weight; the modacrylic fiber is present in an amount of about 20% by weight; and the cellulosic is present in an amount of about 20% by weight.

4. The fabric of claim 1, wherein the flame retardant viscose rayon fiber is inherently flame retardant.

5. The fabric of claim 4, wherein the inherently flame retardant viscose rayon fiber comprises silica.

6. The fabric of claim 4, wherein the inherently flame retardant viscose rayon is not chemically treated.

7. The fabric of claim 1, wherein the flame retardant viscose rayon fiber is chemically treated.

8. The fabric of claim 7, wherein the chemically treated flame retardant viscose rayon fiber is topically coated with a chemical substance.

9. The fabric of claim 7, wherein the flame retardant viscose rayon fiber is chemically treated with ammonia polyphosphate.

10. The fabric of claim 1 or 4, wherein the modacrylic fiber comprises a polymer including halogenated monomers which generate oxygen depleting gases during thermal decomposition.

11. The fabric of claim 10, wherein the cellulosic fiber comprises cotton, non-flame retardant viscose rayon, or a combination thereof.

12. The fabric of claim 1 or 4, wherein the fabric has a spun yarn count of about 5/1 ecc to about 40/1 ecc.

13. The fabric of claim 12, wherein the fabric has a spun yarn count of about 10/1 ecc to about 40/1 ecc.

14. The fabric of claim 12, wherein the fabric has a spun yarn count of about 20/1 ecc to about 40/1 ecc.

15. The fabric of claim 12, wherein the fabric has a spun yarn count of about 20/1 ecc to about 30/1 ecc.

16. The fabric of any one of claims 1-4, wherein the fabric has a weight of about 4 oz.sq.yd. to about 15 oz.sq.yd.

17. The fabric of claim 1, wherein the flame retardant viscose rayon fiber is inherently flame retardant and is not chemically treated, and the modacrylic fiber is not chemically treated.
